(19) United States
(12) Patent Application Publication
(10) Pub. No.: US 2025/0227615 A1
(43) Pub. Date: Jul. 10, 2025

(54) Methods And Apparatus For Enhanced Policy Control With Energy-Related Information In Mobile Communications

(71) Applicant: MediaTek Inc., Hsinchu City (TW)

(72) Inventors: Chia-Lin Lai, Hsinchu City (TW); Mehrdad Shariat, Cambridge (GB); Yuan-Chieh Lin, Hsinchu City (TW); Chien-Sheng Yang, Hsinchu City (TW)

(21) Appl. No.: 18/985,003

(22) Filed: Dec. 17, 2024

Related U.S. Application Data
(60) Provisional application No. 63/619,335, filed on Jan. 10, 2024.

(51) Int. Cl. H04W 52/02; H04W 28/02; H04W 40/08

(52) U.S. Cl. CPC H04W 52/0229; H04W 28/0268; H04W 40/08

(57) ABSTRACT

Various solutions for enhanced policy control with energy-related information in mobile communications are described. An apparatus may receive energy-related information from at least one network function (NF). Then, the apparatus may generate at least one of a user equipment (UE) policy, an access and mobility (AM) policy, and a session management (SM) policy for an apparatus based on the energy-related information. Also, the apparatus may provide the at least one of the AM policy, the SM policy, and the UE policy to the apparatus.

### CROSS REFERENCE TO RELATED PATENT APPLICATION(S)

The present disclosure is part of a non-provisional application claiming the priority benefit of U.S. Patent Application No. 63/619,335, filed 10 Jan. 2024, the content of which herein being incorporated by reference in its entirety.

### TECHNICAL FIELD

The present disclosure is generally related to mobile communications and, more particularly, to enhanced policy control with energy-related information in mobile communications.

### BACKGROUND

Unless otherwise indicated herein, approaches described in this section are not prior art to the claims listed below and are not admitted as prior art by inclusion in this section.

To encourage renewable electricity (or called “green” electricity) adoption, emerging carbon tax/fee (e.g., 10+ United States dollars (USD) per ton of carbon dioxide (CO2)) regulation worldwide is being put in place to raise the cost of traditional electricity (or called “gray” electricity). In response to this trend, leading companies are now pushing their supply chains to neutralize or mitigate carbon footprint in manufacturing and transportation, and new businesses on carbon credit and renewable energy certificate trading are growing rapidly.

It is observed that the Information/Communications Technology (ICT) industry is one of the biggest consumers of electricity. The ICT industry's estimated consumption of worldwide electricity stands at 2-3% today, and it is predicted to increase to around 8-21% by the year of 2030. Hence, it is important for the technology industry to consider not only how to reduce its electricity consumption, but also the transition to cleaner sources of energy. Nevertheless, quantifying and subsequently reducing the consumption of electricity is no easy task, as there are many contributors for a web-based mobile application, including (i) electricity usage of the mobile device running the application; (ii) the infrastructure that carries the application message over the radio link to a cell tower; (iii) the cell tower shared by more than one carrier and the fiber connecting the tower to the Internet backbone networks, owned by various Internet service providers (ISPs); and (iv) the data center runs the application logic in a cloud platform shared by different businesses. In addition to measure the aggregated impact of each of these components to determine the total electricity usage, it is also important to derive the carbon-intensity of energy consumption, in order to determine the carbon footprint of network elements (e.g., hardware and/or software) when they are put into service. Electricity may be generated from various energy sources (e.g., gas, coal, nuclear, wind, and solar energy, etc.) with different levels of carbon emissions. In particular, due to the highly variable and unpredictable nature of renewable energy sources (e.g., wind and solar energy), carbon intensity (i.e., average carbon emissions per unit of energy consumption) of electricity grid varies considerably by time and location. As such, a challenge for carbon emissions reduction in the ICT industry is how to design a signaling framework and/or scheduling policy for applications with eco-friendly requirements in mobile communications, which accounts for temporal and spatial dimensions of energy sources.

Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and/or apparatus pertaining to enhanced policy control with energy-related information in mobile communications. It is believed that the above-described issue would be avoided or otherwise alleviated by implementing one or more of the proposed schemes described herein.

In one aspect, a method may involve a network node receiving energy-related information from at least one network function (NF). The method may also involve the network node generating at least one of a user equipment (UE) policy, an access and mobility (AM) policy, and a session management (SM) policy for an apparatus based on the energy-related information. The method may further involve the network node providing the at least one of the AM policy, the SM policy, and the UE policy to the apparatus.

In one aspect, a method may involve an apparatus receiving at least one of a UE policy, an AM policy, and an SM policy from a network node of a wireless network, wherein the at least one of the UE policy, the AM policy, and the SM policy is generated based on energy-related information. The method may also involve the apparatus determining a data session for an application based on the at least one of the UE policy, the AM policy, and the SM policy. The method may further involve the apparatus routing traffic of the application between the apparatus and the wireless network based on the data session.

In one aspect, a network apparatus, operating as a network node, may comprise a transceiver which, during operation, wirelessly communicates with at least one NF and an apparatus. The network apparatus may also comprise a processor communicatively coupled to the transceiver. The processor, during operation, may perform operations comprising receiving, via the transceiver, energy-related information from the at least one NF. The processor may also perform operations comprising generating at least one of a UE policy, an AM policy, and an SM policy for the apparatus based on the energy-related information. The processor may further perform operations comprising providing, via the transceiver, the at least one of the AM policy, the SM policy, and the UE policy to the apparatus.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of UE route selection policy (URSP) rule generation under the first proposed scheme in accordance with an implementation of the present disclosure.

FIG. 3 is a diagram depicting another example scenario of URSP rule generation under the first proposed scheme in accordance with an implementation of the present disclosure.

FIG. 4 is a diagram depicting an example scenario of energy-related information collection under the third proposed scheme in accordance with an implementation of the present disclosure.

FIG. 5 is a diagram depicting another example scenario of energy-related information collection under the third proposed scheme in accordance with an implementation of the present disclosure.

FIG. 6 is a diagram depicting another example scenario of energy-related information collection under the third proposed scheme in accordance with an implementation of the present disclosure.

FIG. 7 is a block diagram of an example communication system in accordance with an implementation of the present disclosure.

FIG. 8 is a flowchart of an example process in accordance with an implementation of the present disclosure.

FIG. 9 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhanced policy control with energy-related information in mobile communications. According to the present disclosure, a number of possible solutions may be implemented separately or jointly. That is, although these possible solutions may be described below separately, two or more of these possible solutions may be implemented in one combination or another.

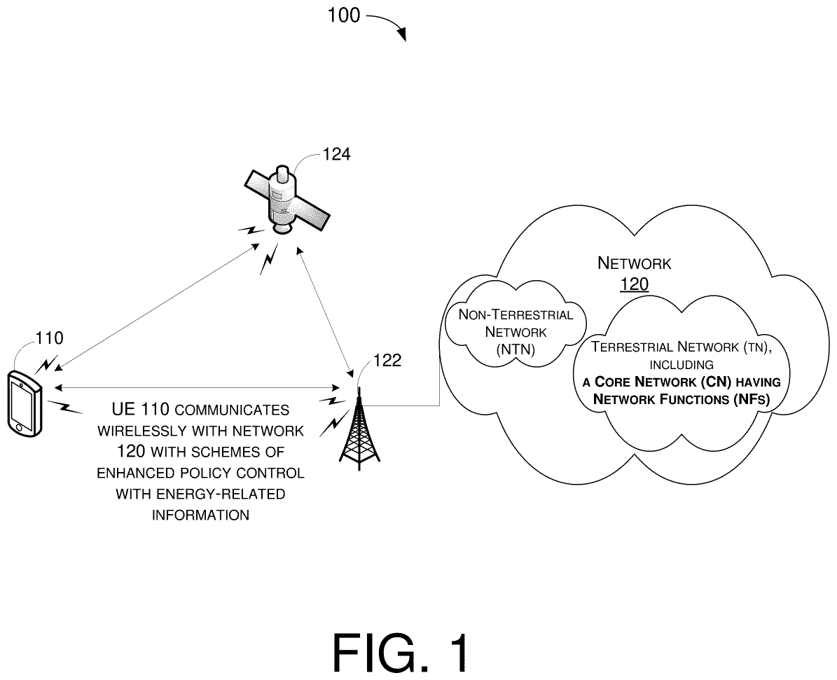

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including a non-terrestrial network (NTN) and a TN) via at least a terrestrial network node 122 (e.g., a base station (BS) such as an evolved Node-B (eNB), a Next Generation Node-B (gNB), or a transmission/reception point (TRP)) and/or at least a non-terrestrial network node 124 (e.g., a satellite). For example, the terrestrial network node 122 may form a TN serving cell for wireless communication with the UE 110, or the terrestrial network node 122 and/or the non-terrestrial network node 124 may form an NTN serving cell for wireless communication with the UE 110. In some implementations, the network 120 may be a 4G/5G/B5G/6G network, and the UE 110 may be a smartphone, a tablet computer, a laptop computer or a notebook computer. Alternatively, the network 120 may be an IoT/NB-IoT/IIoT network, and the UE 110 may be an IoT device such as an NB-IoT UE or an enhanced machine-type communication (eMTC) UE (e.g., a bandwidth reduced low complexity (BL) UE or a coverage enhancement (CE) UE). Although not shown, the TN part of the network 120 may include a core network (CN) containing various network functions (NFs). For example, if the network 120 is a 5G system (5GS), the NFs may include an access and mobility function (AMF), a session management function (SMF), a policy control function (PCF), an operations and maintenance (OAM) entity, a network data analytics function (NWDAF), an application function (AF), a unified data management (UDM), a unified data repository (UDR), and an energy information function (EIF), etc. In such communication environment, the UE 110, the network 120, the terrestrial network node 122, and/or the non-terrestrial network node 124 may implement various schemes pertaining to enhanced policy control with energy-related information in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In particular, the present disclosure addresses the requirements in 3^{rd} Generation Partnership Project (3GPP) standards as follows: (i) subject to operator policy and agreement with 3^{rd} party (e.g., electricity companies), the 5G system shall provide a mechanism to support the selection of an application server based on energy-related information associated with a set of application servers; (ii) subject to operator's policy and agreement with 3^{rd} party, the 5G system shall support a mechanism for the 3^{rd} party to provide current or predicted energy consumption information over a specific period of time; (iii) subject to user consent and operator policy, 5G system shall be able to provide means to modify a communication service based on energy-related information criteria based on subscription policies; and (iv) subject to operator's policy and agreement with 3^{rd} party, the 5G system shall be able to expose information on energy consumption for serving this 3rd party.

Take the Florida state in USA for example. By observing real power grid deployment, it can be seen that different areas of the Florida state have different levels of energy usage pattern depending on the time period(s) and/or location(s), e.g., for the carbon intensity and/or ratio of renewable energy. If an operator covers the entire areas, such as per city or per state, to provide communication services, e.g., Operator A covers the entire areas of the Florida state for providing communication services to their customers, the operator can have the whole topology of carbon intensity distribution since it has the service-level agreement (SLA) with the electricity companies to get the energy-related information, such as energy consumption information, energy efficiency information, renewable energy information, carbon emission information, and an energy saving indicator that the UE is subject to network energy saving operation. For instance, the energy-related information may include the ratio of renewable energy in time and/or location (per network slice), and/or the carbon intensity in time and/or location (per network slice), etc. Furthermore, Operator A may also deploy the network slices all over the areas of the Florida state. Therefore, from the mapping of the deployed network slices and the distribution of the energy-related information provided by the electricity companies, Operator A can influence the UE to route the traffic to an application server via the network slice(s) which are located in the area having lower carbon intensity or higher ratio of renewable energy, e.g., by configuring the UE policies (e.g., URSP rules), AM policies, and/or SM policies based on the energy-related information. However, it is noteworthy that the energy pattern(s) of the carbon intensity and the ratio of renewable energy are dynamic in terms of “time” and “location” per area. For instance, some districts (i.e., “location”) may have solar power supply during daytime (i.e., “time”) to provide the electricity, and if the operator is able to obtain such energy-related information, then it may adjust or guide the UE to use the “greener” network slices which are located in those areas during daytime.

In view of the above, the present disclosure proposes a number of schemes pertaining to enhanced policy control with energy-related information in mobile communications. According to the schemes of the present disclosure, mechanisms are provided to allow the specific NF (e.g., PCF or AMF) to acquire the energy-related information, such that the NF may generate UE policies, AM policies, and/or SM policies based on the energy-related information. Accordingly, the UE may be provided with the UE/AM/SM policies configured with the energy-related information, and by applying the UE/AM/SM policies to use the “greener” network slices, the network resource allocation and utilization may be more eco-friendly or carbon-intelligent/aware.

Under the first proposed scheme in accordance with the present disclosure, the optional fields, e.g., time window and location criteria, of a Route Selection Descriptor (RSD) in a URSP rule may be utilized by the NF (e.g., PCF) in URSP rules generation based on the energy-related information. If these two fields are presented in the RSD of a matched URSP rule, they need to be met before the UE associates an application to a protocol data unit (PDU) session. More specifically, the URSP rules are generated with the time window and location criteria are configured in a way to influence the UE to request “greener” network slice(s).

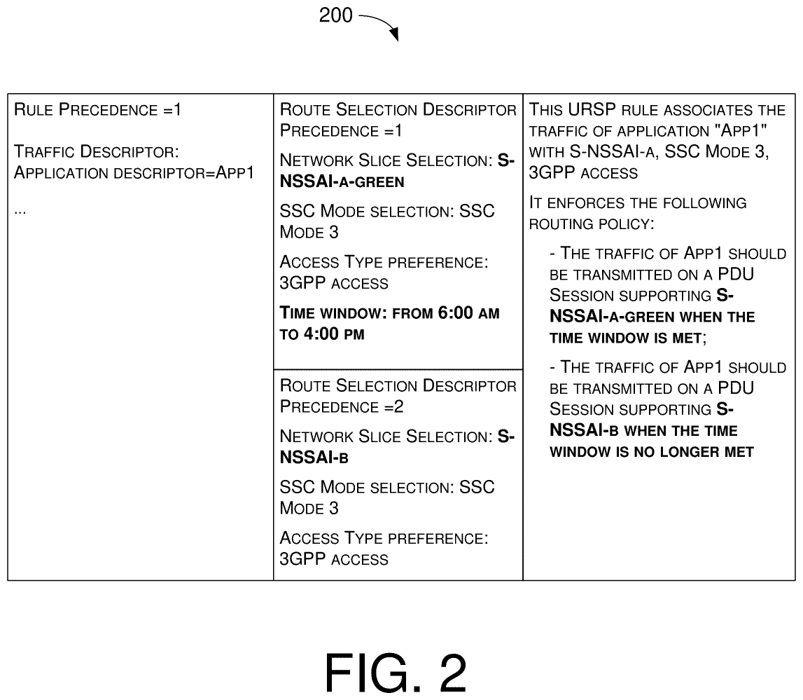

FIG. 2 illustrates an example scenario 200 of URSP rule generation under the first proposed scheme in accordance with an implementation of the present disclosure. In scenario 200, the energy-related information is the time period of using solar supply during daytime (e.g., from 6:00 AM to 4:00 PM), which is used for time window configuration, and when the time is within the time window, the UE may associate with a PDU session supporting “greener” network slice(s) (i.e., network slice(s) deployed for using solar energy) for the application. Specifically, as shown in FIG. 2, the first RSD of the URSP rule indicates a single-network slice selection assistance information (S-NSSAI) (denoted as S-NSSAI-a-green) with a specific time window starting from 6:00 AM to 4:00 PM, while the second RSD of the URSP rule indicates another S-NSSAI (denoted as S-NSSAI-b) without a time window. As such, this enforces the following routing policy: if the “App1” requests a network connection within the time window {6:00 AM to 4:00 PM}, then the UE establishes (if not already established) a PDU session with S-NSSAI-a-green over 3GPP access, and routes the traffic of “App1” over this PDU session; or otherwise, if the “App1” requests a network connection outside the time window {6:00 AM to 4:00 PM}, then the UE establishes (if not already established) a PDU session with S-NSSAI-b over 3GPP access, and routes the traffic of “App1” over this PDU session.

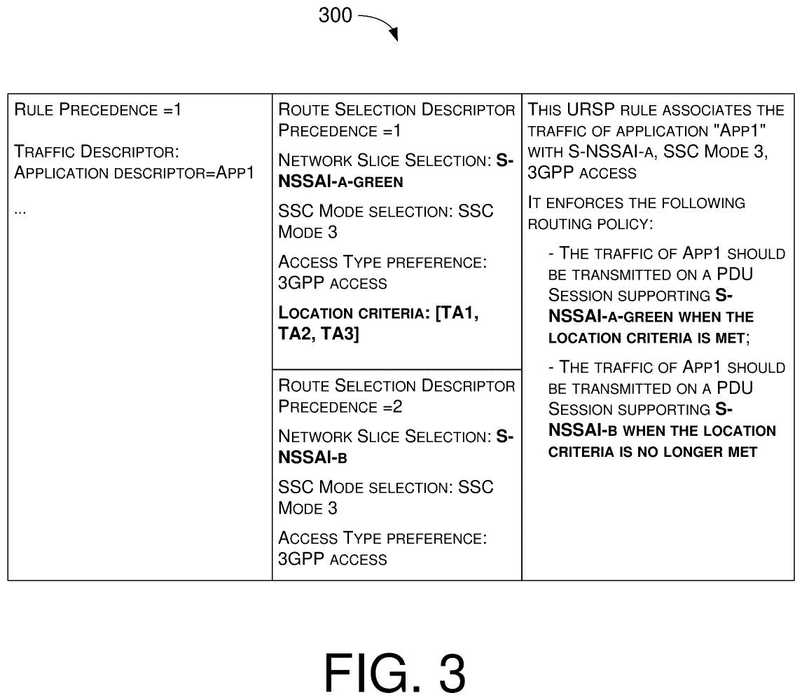

FIG. 3 illustrates an example scenario 300 of URSP rule generation under the first proposed scheme in accordance with an implementation of the present disclosure. In scenario 300, the energy-related information is the location where the solar power is supplied, which is used for location criteria configuration, and when the UE is within the area of the location criteria, the UE may associate with a PDU session supporting “greener” network slice(s) (i.e., network slice(s) deployed for using solar energy) for the application. Specifically, as shown in FIG. 3, the first RSD of the URSP rule indicates an S-NSSAI (denoted as S-NSSAI-a-green) with a location criteria indicating three specific tracking areas (denoted as TA1-TA3), while the second RSD of the URSP rule indicates another S-NSSAI (denoted as S-NSSAI-b) without a location criteria. As such, this enforces the following routing policy: if the “App1” requests a network connection when the UE is within TA1/TA2/TA3, then the UE establishes (if not already established) a PDU session with S-NSSAI-a-green over 3GPP access, and routes the traffic of “App1” over this PDU session; or otherwise, if the “App1” requests a network connection when the UE is not within TA1/TA2/TA3, then the UE establishes (if not already established) a PDU session with S-NSSAI-b over 3GPP access, and routes the traffic of “App1” over this PDU session.

Under the second proposed scheme in accordance with the present disclosure, the optional fields, e.g., validity time and Partially Allowed NSSAI, of the NSSAI information may be utilized by the NF (e.g., AMF) in NSSAI information generation based on the energy-related information. In general, a network slice may be available for UEs for a limited time/location that is known by the network (e.g., OAM and/or NWDAF) in advance. On the other hand, the carbon intensity and the ratio of renewable energy change dynamically depending on time and/or location, e.g., the solar energy can be obtained during daytime, and the wind energy can be obtained in certain areas (e.g., TAs). Therefore, according to the energy-related information, the AMF may generate the NSSAI information with specific validity time/location information for the UE, so as to allow the UE to potentially use the renewable energy in specific time and/or location.

In some implementations, based on the energy-related information (e.g., the time for solar energy is only available during daytime), the AMF may generate the AM policy containing a configured NSSAI with validity time indicating the available time of renewable energy. For instance, the AMF may indicate to a UE the validity time for one or more S-NSSAIs that will be included in the Allowed NSSAI in the Registration Accept message or via the UE configuration update procedure. For a supporting UE, it may request an S-NSSAI with the validity time in a Registration Request message if the validity time indicates that the S-NSSAI is now available for using renewable energy, and it may establish a PDU session associated with this S-NSSAI if this S-NSSAI is included in the Allowed NSSAI or in the Partially Allowed NSSAI. For a non-supporting UE, if the validity time applies to an S-NSSAI, the AMF may include the S-NSSAI in the Allowed NSSAI for the non-supporting UE to establish a PDU session.

In some implementations, based on the energy-related information (e.g., the renewable energy is only available in certain areas), the AMF may generate the AM policy containing a Partially Allowed NSSAI which indicates one or more TA identifiers (TAIs) where at least one S-NSSAI deployed for using wind energy is supported or not supported. For a supporting UE, it may request such S-NSSAI in the Partially Allowed NSSAI and establish a PDU sessions associated with the S-NSSAI, if the current location of the UE is within the TA where the S-NSSAI is deployed for using renewable energy. For non-supporting UE, if a location restriction applies to an S-NSSAI, the AMF may include the S-NSSAI in the Allowed NSSAI for the UE to establish a PDU session.

Alternatively, some parameters such as quality-of-service (QoS) parameter(s) in an SM policy may be utilized by the NF (e.g., PCF/AMF) in SM policy generation based on the energy-related information. For instance, PCF may update or adjust the QoS parameters, such as guaranteed flow bit rate (GFBR), and maximum flow bit rate (MFBR), etc., based on the energy-related information. In another example, alternative QoS profiles can be generated based on the energy-related information.

Under the third proposed scheme in accordance with the present disclosure, new signaling procedures are designed for the PCF/AMF to collect/receive the energy-related information from another NF(s), such as OAM/NWDAF, AF (via network exposure function (NEF)), UDM/UDR, or energy management function (EMF) (i.e., EIF). Specifically, the energy-related information, such as energy consumption information, energy efficiency information, renewable energy information, and/or carbon emission information may be obtained from the electricity companies and then provided to PCF/AMF when requested. In addition, the energy-related information, such as the energy saving indicator that a UE is subject to network energy saving operation, may be included in the subscription data for the UE, and the AMF may retrieve it from the UE subscription data and forward it to the PCF.

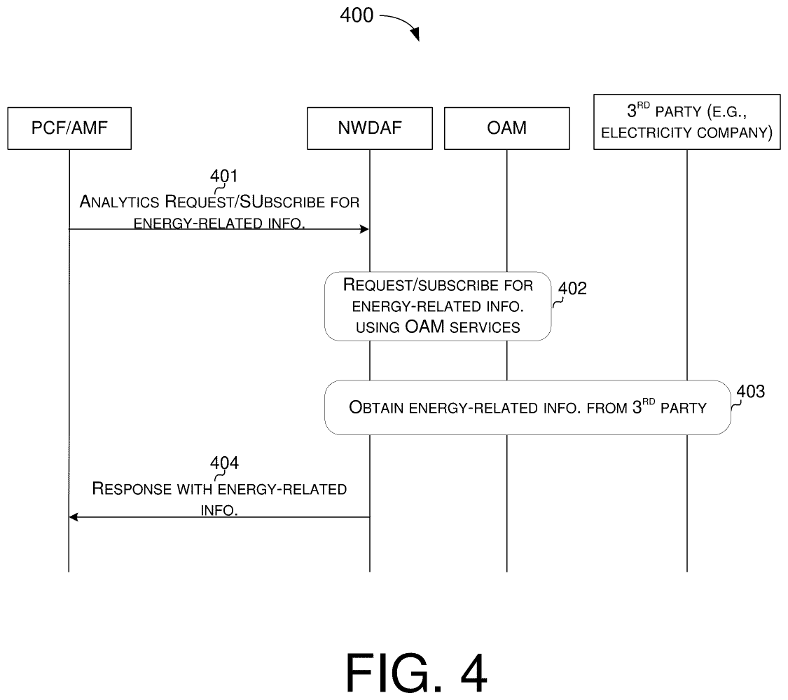

FIG. 4 illustrates an example scenario 400 of energy-related information collection under the third proposed scheme in accordance with an implementation of the present disclosure. Scenario 400 depicts the signaling procedure for the PCF/AMF to collect/receive the energy-related information from the OAM/NWDAF. In step 401, the PCF/AMF (as a consumer NF), if enabled to support energy-related information, may transmit an analytics request/subscribe to the NWDAF for the energy-related information. The request or subscription may include either a new Analytics ID dedicated for “energy-related Information” or an existing Analytics ID (e.g., “service experience”) combined with Analytics Filters including, e.g., Application ID, S-NSSAI, data network name (DNN), Area of Interest, etc. In step 402, the NWDAF may request/subscribe to the OAM using the existing procedures defined in 3GPP standards to collect the energy-related information (in a similar way that Cell Energy Saving State is collected). Alternatively, the NWDAF may collect analysis on Energy Saving State or other energy-related information via the management data analytics function (MDAF). In step 403, the OAM (or MDAF) may obtain the energy-related information from the 3^{rd} party (e.g., electricity company) and respond to the NWDAF's request/subscription. Then, in step 404, the NWDAF may reply to the PCF/AMF with a response containing analytics about the energy-related information. It is noteworthy that the existing NWDAF services and possibly Analytics ID(s) and/or Analytics Filters are enhanced to support the energy-related information.

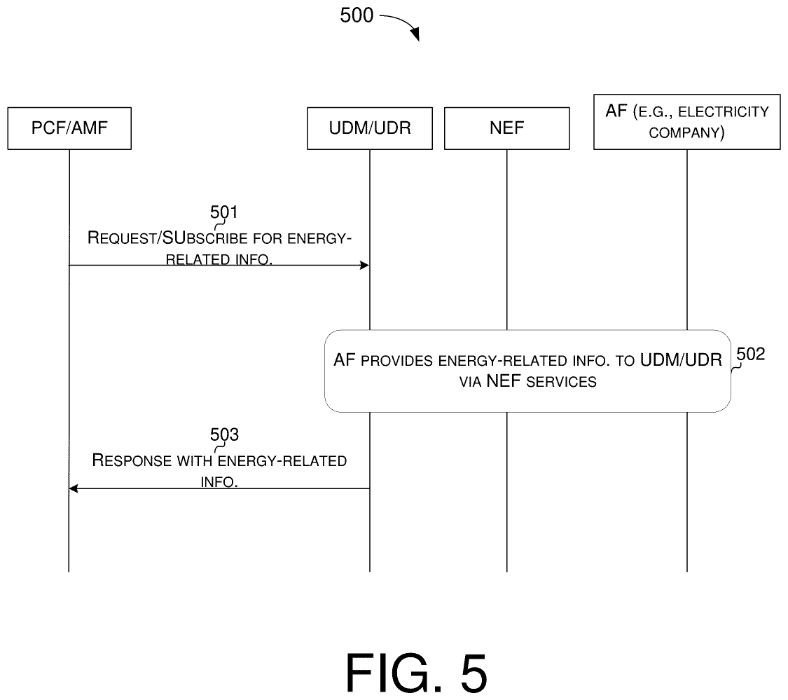

FIG. 5 illustrates an example scenario 500 of energy-related information collection under the third proposed scheme in accordance with an implementation of the present disclosure. Scenario 500 depicts the signaling procedure for the PCF/AMF to collect/receive the energy-related information from the UDM/DUR/AF (via NEF). In step 501, the PCF/AMF (as a consumer NF), if enabled to support energy-related information, may transmit a request/subscribe to the UDM/UDR for the energy-related information. In step 502, the AF may provide the energy-related information to the UDM/UDR using the existing procedures defined in 3GPP standards (i.e., using NEF services). In step 503, the UDM/UDR may reply to the PCF/AMF with a response containing the energy-related information. It is noteworthy that the existing data collection and exposure procedures from UDM/DUR/AF are enhanced to support the energy-related information.

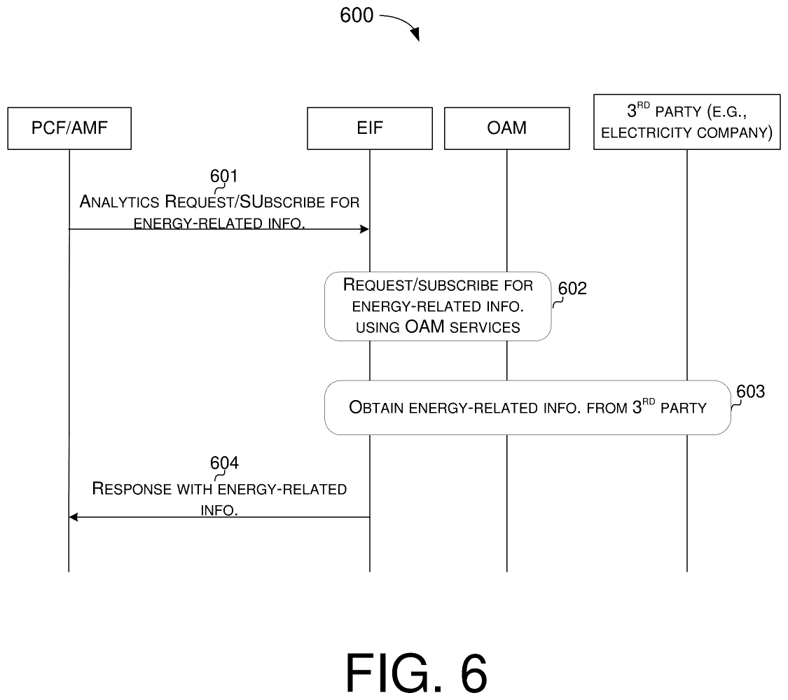

FIG. 6 illustrates an example scenario 600 of energy-related information collection under the third proposed scheme in accordance with an implementation of the present disclosure. Scenario 600 depicts the signaling procedure for the PCF/AMF to collect/receive the energy-related information from the EIF. In step 601, the PCF/AMF (as a consumer NF), if enabled to support energy-related information, may transmit a request/subscribe to the EIF for the energy-related information. In step 602, the EIF may request/subscribe to the OAM/NDAF using OAM services. In step 603, the OAM/MDAF may obtain the energy-related information from the 3^{rd} party (e.g., electricity company) and configure the EIF with the obtained energy-related information. Then, in step 604, the EIF may reply to the PCF/AMF with a response containing analytics about the energy-related information. It is noteworthy that the existing data collection and exposure procedures from OAM/MDAF are enhanced to support the energy-related information. In some implementations, a new reference point of Neif and associated services may be required to enable the consumer NF (e.g., PCF, AMF) to obtain the energy-related information.

### Illustrative Implementations

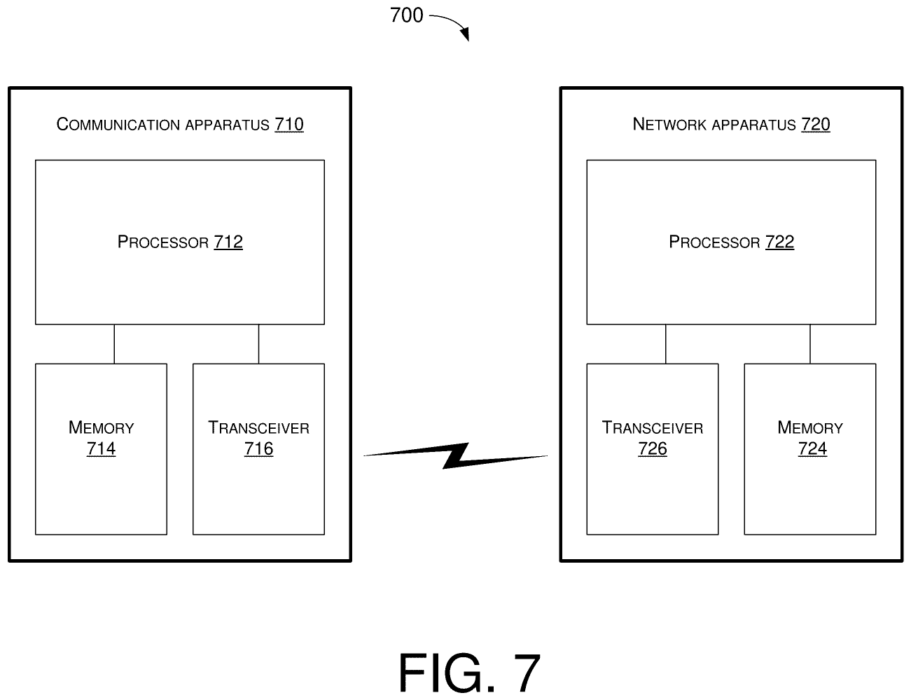

FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to enhanced policy control with energy-related information in mobile communications, including scenarios/schemes described above as well as processes 800 and 900 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 710 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed schemes of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of an electronic apparatus, which may be a network node such as a satellite, a BS, a small cell, a router or a gateway of an IoT network. For instance, network apparatus 720 may be implemented in a satellite or an eNB/gNB/TRP in a 4G/5G/B5G/6G, NR, IoT, NB-IoT or IIoT network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks, including enhanced policy control with energy-related information, in a device (e.g., as represented by communication apparatus 710) and a network node (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In some implementations, transceiver 716 may be capable of wirelessly communicating with different types of UEs and/or wireless networks of different radio access technologies (RATs). In some implementations, transceiver 716 may be equipped with a plurality of antenna ports (not shown) such as, for example, four antenna ports. That is, transceiver 716 may be equipped with multiple transmit antennas and multiple receive antennas for multiple-input multiple-output (MIMO) wireless communications. In some implementations, network apparatus 720 may also include a transceiver 726 coupled to processor 722. Transceiver 726 may include a transceiver capable of wirelessly transmitting and receiving data. In some implementations, transceiver 726 may be capable of wirelessly communicating with different types of UEs of different RATs. In some implementations, transceiver 726 may be equipped with a plurality of antenna ports (not shown) such as, for example, four antenna ports. That is, transceiver 726 may be equipped with multiple transmit antennas and multiple receive antennas for MIMO wireless communications.

In some implementations, communication apparatus 710 may further include a memory 714 coupled to processor 712 and capable of being accessed by processor 712 and storing data therein. In some implementations, network apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 710 and network apparatus 720 may be a communication entity capable of communicating with each other using various proposed schemes in accordance with the present disclosure. For illustrative purposes and without limitation, a description of capabilities of communication apparatus 710, as a UE, and network apparatus 720, as a network node (e.g., AMF/UPF), is provided below with processes 800 and 900.

### Illustrative Processes

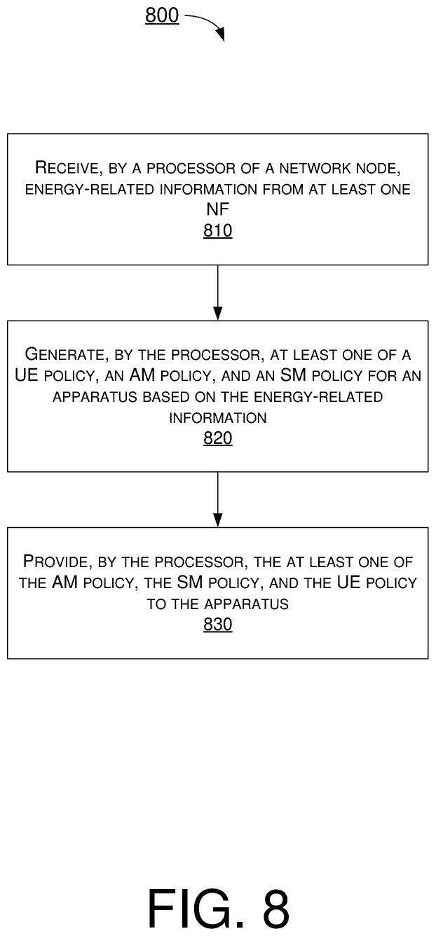

FIG. 8 illustrates an example process 800 in accordance with an implementation of the present disclosure. Process 800 may be an example implementation of above scenarios/schemes, whether partially or completely, with respect to enhanced policy control with energy-related information in mobile communications. Process 800 may represent an aspect of implementation of features of network apparatus 720. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively in a different order. Process 800 may be implemented by or in network apparatus 720 as well as any variations thereof. Solely for illustrative purposes and without limiting the scope, process 800 is described below in the context of communication apparatus 710, as a UE, and network apparatus 720, as a network node (e.g., UPF/AMF). Process 800 may begin at block 810.

At 810, process 800 may involve processor 722 of network apparatus 720 receiving energy-related information from at least one NF. Process 800 may proceed from 810 to 820.

At 820, process 800 may involve processor 722 generating at least one of a UE policy, an AM policy, and an SM policy for communication apparatus 710 based on the energy-related information. Process 800 may proceed from 820 to 830.

At 830, process 800 may involve processor 722 providing the at least one of the AM policy, the SM policy, and the UE policy to communication apparatus 710.

In some implementations, the energy-related information may include at least one of the following: energy consumption information; energy efficiency information; renewable energy information; carbon emission information; and an energy saving indicator that communication apparatus 710 is subject to network energy saving operation.

In some implementations, the at least one NF may include at least one of the following: an OAM entity; an NWDAF; an AF; a UDM entity; a UDR entity; an EIF; and an AMF.

In some implementations, the UE policy may include a URSP rule, and an RSD of the URSP rule may include at least one of a time window and a location criteria, each of which is determined based on the energy-related information.

In some implementations, the AM policy may indicate a network slice with validity information which is determined based on the energy-related information, and the validity information indicates at least one of a validity time and a validity location.

In some implementations, the SM policy may include a QoS requirement which is determined based on the energy-related information.

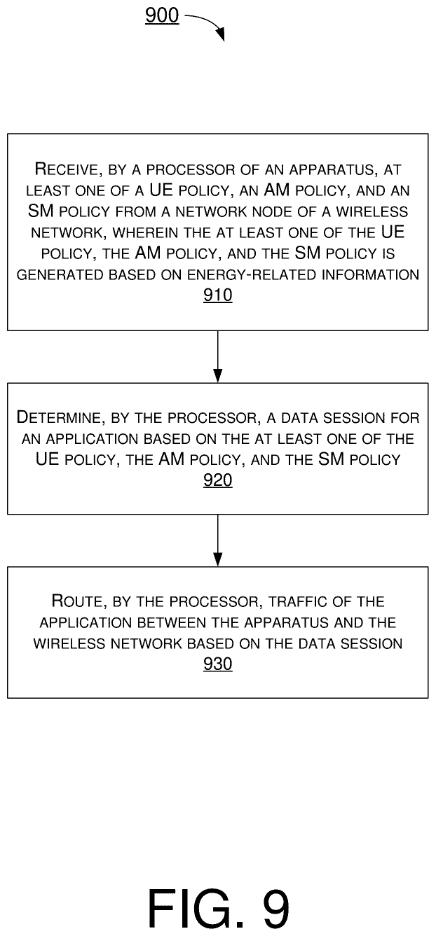

FIG. 9 illustrates an example process 900 under schemes in accordance with an implementation of the present disclosure. Process 900 may represent an aspect of implementing various proposed designs, concepts, schemes, systems and methods described above, whether partially or entirely, with respect to enhanced policy control with energy-related information in mobile communications. Process 900 may represent an aspect of implementation of features of communication apparatus 710. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively in a different order. Process 900 may be implemented by or in communication apparatus 710 or any suitable UE or machine type device. Solely for illustrative purposes and without limiting the scope, process 900 is described below in the context of communication apparatus 710, as a UE, and network apparatus 720, as a network node (e.g., UPF/AMF). Process 900 may begin at block 910.

At 910, process 900 may involve processor 712 of communication apparatus 710 receiving, via transceiver 726, at least one of a UE policy, an AM policy, and an SM policy from network apparatus 720 of a wireless network, wherein the at least one of the UE policy, the AM policy, and the SM policy is generated based on energy-related information. Process 900 may proceed from 910 to 920.

At 920, process 900 may involve processor 712 determining a data session for an application based on the at least one of the UE policy, the AM policy, and the SM policy. Process 900 may proceed from 920 to 930.

At 930, process 900 may involve processor 712 routing traffic of the application between communication apparatus 710 and the wireless network based on the data session.

In some implementations, the energy-related information may include at least one of the following: energy consumption information; energy efficiency information;

renewable energy information; carbon emission information; and an energy saving indicator that communication apparatus 710 is subject to network energy saving operation.

In some implementations, the at least one NF may include at least one of the following: an OAM entity; an NWDAF; an AF; a UDM entity; a UDR entity; an EIF; and an AMF.

In some implementations, the UE policy may include a URSP rule, and an RSD of the URSP rule may include at least one of a time window and a location criteria, each of which is determined based on the energy-related information.

In some implementations, the AM policy may indicate a network slice with validity information which is determined based on the energy-related information, and the validity information indicates at least one of a validity time and a validity location.

In some implementations, the SM policy may include a QoS requirement which is determined based on the energy-related information.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a network node, energy-related information from at least one network function (NF);
generating, by the processor, at least one of a user equipment (UE) policy, an access and mobility (AM) policy, and a session management (SM) policy for an apparatus based on the energy-related information; and
providing, by the processor, the at least one of the AM policy, the SM policy, and the UE policy to the apparatus.

2. The method of claim 1, wherein the energy-related information comprises at least one of the following:
energy consumption information;
energy efficiency information;
renewable energy information;
carbon emission information; and
an energy saving indicator that the apparatus is subject to network energy saving operation.

3. The method of claim 1, wherein the at least one NF comprises at least one of the following:
an operations and maintenance (OAM) entity;
a network data analytics function (NWDAF);
an application function (AF);
a unified data management (UDM) entity;
a unified data repository (UDR) entity;
an energy information function (EIF); and
an access and mobility management function (AMF).

4. The method of claim 1, wherein the UE policy comprises a UE route selection policy (URSP) rule, and a route selection descriptor (RSD) of the URSP rule comprises at least one of a time window and a location criteria, each of which is determined based on the energy-related information.

5. The method of claim 1, wherein the AM policy indicates a network slice with validity information which is determined based on the energy-related information, and the validity information indicates at least one of a validity time and a validity location.

6. The method of claim 1, wherein the SM policy comprises a quality-of-service (QoS) parameter which is determined based on the energy-related information.

7. The method of claim 1, wherein the network node comprises a policy control function (PCF) or an access and mobility management function (AMF).

8. A method, comprising:
receiving, by a processor of an apparatus, at least one of a user equipment (UE) policy, an access and mobility (AM) policy, and a session management (SM) policy from a network node of a wireless network, wherein the at least one of the UE policy, the AM policy, and the SM policy is generated based on energy-related information;
determining, by the processor, a data session for an application based on the at least one of the UE policy, the AM policy, and the SM policy; and
routing, by the processor, traffic of the application between the apparatus and the wireless network based on the data session.

9. The method of claim 8, wherein the energy-related information comprises at least one of the following:
energy consumption information;
energy efficiency information;
renewable energy information;
carbon emission information; and
an energy saving indicator that the apparatus is subject to network energy saving operation.

10. The method of claim 8, wherein the UE policy comprises a UE route selection policy (URSP) rule, and a route selection descriptor (RSD) of the URSP rule comprises at least one of a time window and a location criteria, each of which is determined based on the energy-related information.

11. The method of claim 8, wherein the AM policy indicates a network slice with validity information which is determined based on the energy-related information, and the validity information indicates at least one of a validity time and a validity location.

12. The method of claim 8, wherein the SM policy comprises a quality-of-service (QoS) parameter which is determined based on the energy-related information.

13. The method of claim 8, wherein the network node comprises a policy control function (PCF) or an access and mobility management function (AMF).

14. A network apparatus, operating as a network node, comprising:
a transceiver which, during operation, communicates with at least one network function (NF) and an apparatus; and
a processor communicatively coupled to the transceiver such that, during operation, the processor performs operations comprising:
receiving, via the transceiver, energy-related information from the at least one NF;
generating at least one of a user equipment (UE) policy, an access and mobility (AM) policy, and a session management (SM) policy for the apparatus based on the energy-related information; and
providing, via the transceiver, the at least one of the AM policy, the SM policy, and the UE policy to the apparatus.

15. The network apparatus of claim 14, wherein the energy-related information comprises at least one of the following:
energy consumption information;
energy efficiency information;
renewable energy information;
carbon emission information; and
an energy saving indicator that the apparatus is subject to network energy saving operation.

16. The network apparatus of claim 14, wherein the at least one NF comprises at least one of the following:
an operations and maintenance (OAM) entity;
a network data analytics function (NWDAF);
an application function (AF);
a unified data management (UDM) entity;
a unified data repository (UDR) entity;
an energy information function (EIF); and
an access and mobility management function (AMF).

17. The network apparatus of claim 14, wherein the UE policy comprises a UE route selection policy (URSP) rule, and a route selection descriptor (RSD) of the URSP rule comprises at least one of a time window and a location criteria, each of which is determined based on the energy-related information.

18. The network apparatus of claim 14, wherein the AM policy indicates a network slice with validity location information which is determined based on the energy-related information, and the validity information indicates at least one of a validity time and a validity location.

19. The network apparatus of claim 14, wherein the SM policy comprises a quality-of-service (QoS) parameter which is determined based on the energy-related information.

20. The network apparatus of claim 14, wherein the network node comprises a policy control function (PCF) or an access and mobility management function (AMF).
